(19) United States
(12) Patent Application Publication
(10) Pub. No.: US 2022/0198127 A1
(43) Pub. Date: Jun. 23, 2022

(54) ENHANCEMENT AWARE TEXT TRANSITION

(71) Applicant: International Business Machines Corporation, Armonk, NY (US)

(72) Inventors: Heather Saunders, Raleigh, NC (US); Kelly Camus, Durham, NC (US); Dana L. Price, Surf City, NC (US)

(21) Appl. No.: 17/128,468

(22) Filed: Dec. 21, 2020

(51) Int. Cl. G06F 40/117; G06F 40/106; G06F 40/126; G06F 40/109; G06F 40/166

(52) U.S. Cl. CPC G06F 40/117; G06F 40/106; G06F 40/166; G06F 40/109; G06F 40/126

(57) ABSTRACT

A text transfer initiation directed towards a source text stream, located in a source processing environment, is detected. A source subset of one or more source text enhancement capabilities of the source processing environment is identified. The source subset of the source text enhancement capabilities is applied to the source text stream. A text transfer invocation of the source text stream that is directed towards a target processing environment is identified. The source subset is compared to one or more target text enhancement capabilities of the target processing environment. One or more alternative enhancements to the source subset are determined based on the comparison. A target text stream that includes one or more alternative text enhancements, selected from the target text enhancement capabilities, is generated. A second text transfer invocation, that is directed towards the target processing environment, is performed. The second text transfer invocation includes the target text stream.

### BACKGROUND

The present disclosure relates to text manipulation, and more specifically, to altering the format of text between applications while maintaining context.

Text manipulation in a multiple application environment may benefit from text transfers. Text transfer may include selecting text for the purpose of moving text, such as a cut. Text transfers may include selecting text for the purpose of moving a copy of text, such as copy. Text transfers may permit a user to transfer the selected text into a second application, such as a paste.

### SUMMARY

According to embodiments, disclosed are a method, system, and computer program product. A text transfer initiation that is directed towards a source text stream is detected. The source text stream is located in a source processing environment. A source subset of one or more source text enhancement capabilities of the source processing environment is identified. The source subset of the source text enhancement capabilities is applied to the source text stream. A text transfer invocation of the source text stream is identified. The text transfer invocation is directed towards a target processing environment. The source subset is compared to one or more target text enhancement capabilities of the target processing environment. One or more alternative enhancements to the source subset are determined based on the comparison. A target text stream that includes one or more alternative text enhancements is generated. The one or more alternative text enhancements are selected from the one or more target text enhancement capabilities. A second text transfer invocation that is directed towards the target processing environment is performed. The second text transfer invocation includes the target text stream.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts the representative major components of an example computer system that may be used, in accordance with some embodiments of the present disclosure;

FIG. 2 depicts an example computing environment utilizing, an enhancement aware text transition (EATT) consistent with some embodiments of the disclosure; and

FIG. 3 depicts an example method for performing EATT to manipulate text between source and target processing environments, consistent with some embodiments of the disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to text manipulation; more particular aspects relate to altering the format of text between applications while maintaining context. While the present disclosure is not necessarily limited to such applications, various aspects of the disclosure may be appreciated through a discussion of various examples using this context.

Users of computer systems (computers) may include the use of many different processing environments while developing text. For example, writing of scientific papers or composing of blog posts may include the use of multiple text creation processing environments. Processing environments may be software applications, web-based interfaces (e.g., a website hosting a text field), micro-applications (e.g., text tools, etc.). In the process of composing text, users may wish to have the text moved from one processing environment to another. For example, text may be crafted in a word processor application, and users may wish to move the text to a web-browser or a note-taking application. Users may perform a text transfer by cutting or copying the text from a source processing environment and pasting the text into a target processing environment.

A text transfer may cause issues with the enhancements applied to the text. Specifically, during text composition, text may be altered with one or more text enhancements. Text enhancements may include the use of typography to use one or more forms of text. Typography may include typefaces (e.g., italic text, bold text, condensed text), point sizes (e.g., twelve-point, sixteen-point), line lengths, line-spacing, letter-spacing, and kerning. Text enhancements may include the availability and usage of glyphs, characters, or other relevant symbols (e.g., circular bullets, diamond bullets, rotated heavy black heart bullets, arrows, Roman numerals).

Oftentimes trying to paste text into a field that doesn't support the same text enhancements that were copied from a source processing environment leads to multiple frustrations. The paste may lead to erroneous formatting, for example, garbled text or symbols. Another issue is that additional characters may be inserted that need to be removed by hand or manually changed. The manual changes may cause a lot of extra work to readjust the text for formatting. For example, in certain cases, additional carriage returns must be removed. In another example, the source processing environment may require multiple inputs from a user of carriage returns and backspacing to get a target field to recognize the text should be a numbered list.

Certain text-processing systems may operate on structured text. For example, spreadsheet applications may each work with columns, rows, or cells for acceptance of text in an agreed upon format. Other target spreadsheet applications may understand the agreed upon format and changes may be saved between the source spreadsheet application and the target spreadsheet applications. This is limited, however, as not all text is structured. Often, unstructured text may be preferred as users may want to write more text than a single line of a cell of a spreadsheet application. Structured text may not support various typesetting and typographical options, such as bulleted lists, ordered lists, various tabs and white spacing, and other relevant arrangements of text. Additionally, not all text entry programs adhere to the agreed upon structured text standards of spreadsheets.

Further, certain text transfer systems may not remember user preferences regarding text transfers. Unfortunately, this means that if a user has a preferred way of changing from a source processing environment to a target processing environment, the changes may have to be performed multiple times or across multiple documents. For example, each time a user pastes text into a target processing environment, any alternates for incompatible text enhancements may need to be repeated for each paste. Another drawback is that the conversion in some text transfer systems may be a downgrade, such as a plain text from rich text conversion. The downgraded conversion may result in a user having to manually create, in the target processing environment, any text enhancements that they were used to making in the source processing environment. For example, a user may paste, from a source processing environment, a numbered list into a target processing environment. The target processing environment may not support a numbered list, and so pasted text may be in the form of plain text letters and numbers. Though it appears to be a numbered list, if a user enters new entrees in the target processing environment, the numbered list may not react as the user expects. Resultantly, any new entries, or carriage returns provided by the user may not continue the numbered list.

Embodiments of the present disclosure may describe an enhancement aware text transition (EATT). The EATT may be embodied in a method, system, and computer program product configured to implement text transitions between disparate text processing environments. The EATT may operate by comparing the text enhancement capabilities of a source processing environment to the capabilities for text enhancement of a target processing environment. The EATT may determine if there are equivalent text enhancements between the source and target processing environments. The EATT may also determine that one or more alternative enhancements of the source processing environment have no equivalent text enhancements in a target processing environment. For example, a source processing environment may support bold text, but a target processing environment may not support bold text. The EATT may perform recognition of various text enhancements that are performed on unstructured text. For example, the EATT may perform substitution of alternative forms of categorization of font size, bold, italic, or other relevant alternative fonts; alternatives for special characters, symbols, and marks; and particular spacing and whitespace characters and layout options.

The EATT may operate outside of a source or target processing environment to preserve the text enhancements. For example, if a source environment supports various features of rich text, the EATT may preserve the text enhancements in a target processing environment that only supports plain text. The preservation of text enhancements may allow a user to perform text composition and formatting more quickly, preventing confusion when text is transferred from one application to another. The EATT may operate based on a mapping that is generated for each source processing environment to a target processing environment. For example, a first application text replacement mapping may be created for copying from a word processor to a note-taking application. Further, a second application text replacement mapping may be created for copying from a text editor to a web browser. The text replacement mapping may be created based on a comparison of the text enhancement capabilities of the source and target.

The EATT may select alternatives that that relay a similar meaning/context based on the capabilities of a target processing environment that lacks particular text enhancement capabilities. For example, a source text stream from a source processing environment may include bold text and a target processing environment may not support any customizations to the typography, but only plain text. The EATT may intelligently alter the bold text in the text stream before the text transfer is completed by changing the bold text to uppercase text.

The EATT may update the alteration process dynamically as a user uses the system. For example, a user may perform a text transfer from a text editor to a note-taking application. The EATT may alter bold text by replacing it with uppercase text. The user may undo, or change the altered uppercase text by deleting it, and replacing it with small capitalized text. The EATT may record the user preferences. In a second text transfer, the EATT may alter bold text by replacing it with capitalized text, based on the user preferences that were recorded. The user preferences may be recorded in the application text replacement mapping that is associated with the text transfer between the text editor and the note-taking application.

In some embodiments, the EATT may update user preferences based on detecting a special input by a user. The special input may be a special keyboard click, mouse click, touch gesture, or combination thereof. For example, the EATT may generate a second text transfer invocation into a note -taking application by changing bold text to uppercase text. A user may perform a special input by holding a “control” key and—while holding the “control” key—further press the “U” key. In response to detecting the special input, the EATT may monitor the user action in the note -taking application. The user may alter or update the target text stream that was transferred by the EATT to change uppercase text to small caps text. The EATT may analyze the updates to the target text stream to identify that the target text enhancement was changed from uppercase text to small caps text. The EATT may update a preference entry related to the replacement of bold text to the note-taking application based on the analysis. Based on the updated preference entry, future text transfer invocations that are generated by the EATT may include small caps text for replacement of bold characters.

In some embodiments, there may be separate mappings stored in a datastore for each application text replacement mapping that is associated with each source and target processing environment. In some embodiments, a single mapping may be stored for each application text replacement mapping that is associated with each source and target processing environment. For example, Table 1 depicts a single example application text replacement mapping.

TABLE 1

| Source | Target | | | System/ |
|---|---|---|---|---|
| Processing | Processing | Source | Target | User |
| Environment | Environment | Enhancement | Enhancement | Selected |
| Worder | Noter | bold | small-caps | system |
| Worder | Noter | bold | uppercase | system |
| Worder | Weber | arrow | dash-greater | user |
| Noter | Weber | bulleted list | asterisk | user |
| Noter | Weber: site1URL | tab | three-space | system |

Given the first entry of Table 1 (i.e., the first row), the EATT may perform a text transfer from the word processing application “Worder” to the note-taking utility “Noter” by changing any bold text to text that uses the alternate glyph uppercase letters with reduced height and weight. The EATT may alternatively perform the text transfer from the word processing application “Worder” to the note-taking utility “Noter” by changing any bold text to text that uses all uppercase characters. Further, arrow characters in “Worder” may be changed, by default to hyphens in “Noter”, to a combination of a dash and a greater-than symbol based on a user alteration of the text transfer by a user. Further, “Noter” may support tab characters and bulleted lists in the entry of unstructured text. A web browser “Weber” may not support bulleted lists for text input globally. A bulleted list in “Noter” may be changed, by default to hyphens in “Weber”, but may be changed to an asterisk symbol based on a user alteration of the text transfer by a user. “Weber” may also have website specific text enhancements, e.g., sitel may not support tab characters. Based on the application text replacement mapping of Table 1, any tab characters in unstructured text from sitel may be replaced with three blank space characters.

The EATT may operate by updating the text of a target processing environment based on monitoring a target environment after performing a text transfer. For example, a target processing environment may be a note-taking application that has just received a text transfer. The note-taking application may support plain text, and a user may have pasted a bulleted list. The EATT may record an application text replacement mapping that is associated with a source processing environment and the target note-taking application. Based on the application text replacement mapping, it may be recorded that a line that starts with a bullet character is a text section of bulleted list. The EATT may monitor and detect that a user is providing a carriage return into the text section that is a bulleted list. The EATT, responsively, may intercept the text input of the carriage return and may generate a new line character and a bullet character. The EATT may subsequently insert the new line character and the bullet character. To the user, it may appear that the note-taking application supports bulleted lists based on the operation of intercepting, generating, and inserting characters based on detection and analysis performed by the EATT.

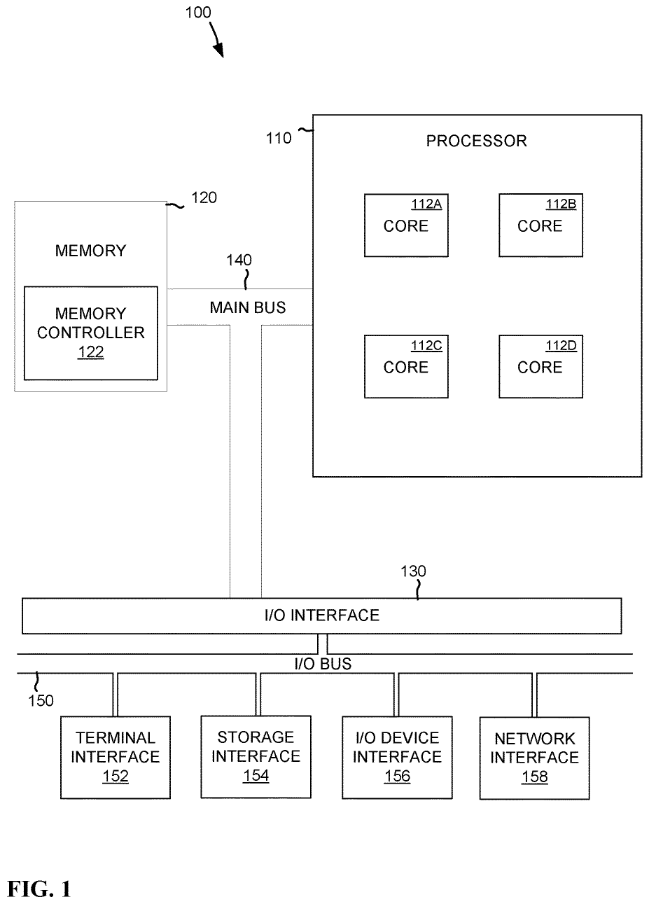

FIG. 1 depicts the representative major components of an example computer system 100 (alternatively, computer) that may be used, in accordance with some embodiments of the present disclosure. It is appreciated that individual components may vary in complexity, number, type, and/or configuration. The particular examples disclosed are for example purposes only and are not necessarily the only such variations. The computer system 100 may comprise a processor 110, memory 120, an input/output interface (herein I/O or I/O interface) 130, and a main bus 140. The main bus 140 may provide communication pathways for the other components of the computer system 100. In some embodiments, the main bus 140 may connect to other components such as a specialized digital signal processor (not depicted).

The processor 110 of the computer system 100 may be comprised of one or more cores 112A, 112B, 112C, 112D (collectively 112). The processor 110 may additionally include one or more memory buffers or caches (not depicted) that provide temporary storage of instructions and data for the cores 112. The cores 112 may perform instructions on input provided from the caches or from the memory 120 and output the result to caches or the memory. The cores 112 may be comprised of one or more circuits configured to perform one or more methods consistent with embodiments of the present disclosure. In some embodiments, the computer system 100 may contain multiple processors 110. In some embodiments, the computer system 100 may be a single processor 110 with a singular core 112.

The memory 120 of the computer system 100 may include a memory controller 122. In some embodiments, the memory 120 may comprise a random-access semiconductor memory, storage device, or storage medium (either volatile or non-volatile) for storing data and programs. In some embodiments, the memory may be in the form of modules (e.g., dual in-line memory modules). The memory controller 122 may communicate with the processor 110, facilitating storage and retrieval of information in the memory 120. The memory controller 122 may communicate with the I/O interface 130, facilitating storage and retrieval of input or output in the memory 120.

The I/O interface 130 may comprise an I/O bus 150, a terminal interface 152, a storage interface 154, an I/O device interface 156, and a network interface 158. The I/O interface 130 may connect the main bus 140 to the I/O bus 150. The I/O interface 130 may direct instructions and data from the processor 110 and memory 120 to the various interfaces of the I/O bus 150. The I/O interface 130 may also direct instructions and data from the various interfaces of the I/O bus 150 to the processor 110 and memory 120. The various interfaces may include the terminal interface 152, the storage interface 154, the I/O device interface 156, and the network interface 158. In some embodiments, the various interfaces may include a subset of the aforementioned interfaces (e.g., an embedded computer system in an industrial application may not include the terminal interface 152 and the storage interface 154).

Logic modules throughout the computer system 100—including but not limited to the memory 120, the processor 110, and the I/O interface 130—may communicate failures and changes to one or more components to a hypervisor or operating system (not depicted). The hypervisor or the operating system may allocate the various resources available in the computer system 100 and track the location of data in memory 120 and of processes assigned to various cores 112. In embodiments that combine or rearrange elements, aspects and capabilities of the logic modules may be combined or redistributed. These variations would be apparent to one skilled in the art.

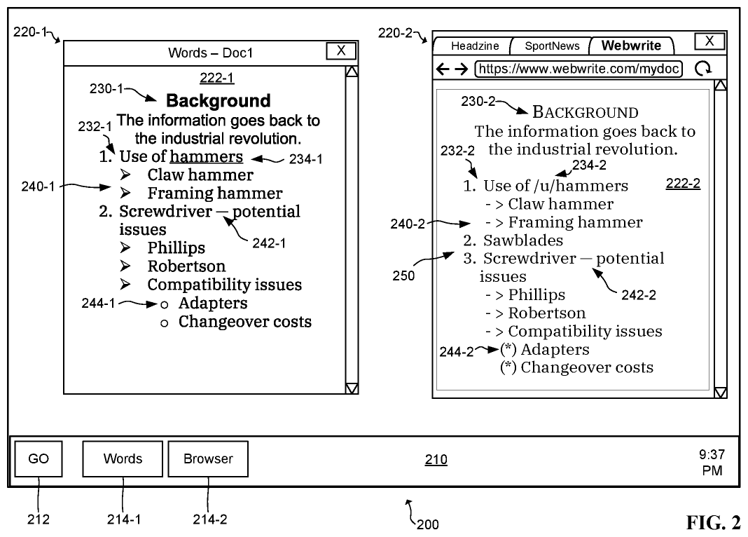

FIG. 2 depicts an example computing environment 200 utilizing an enhancement aware text transition (EATT) consistent with some embodiments of the disclosure. The computing environment 200 may incorporate a desktop operating system (e.g., a computer system 100). The EATT may execute as an operating system process, such as a daemon, task, job, or other relevant processing construct. The EATT may execute with elevated privileges on the operating system of computing environment 200. For example, the EATT may monitor input/output from a keyboard connected to the computing environment 200. A non-exhaustive list of components of computing environment 200 are described in more detail in FIG. 1

The computing environment 200 may display the following: a task switcher 210, a task initializer 212, and two running processing environments 214-1 and 214-2 (collectively applications 214). The applications 214 may include a text editor 214-1 and a web browser 214-2. The text editor 214-1 may include an editor window 220-1 and the web browser 214-2 may include a browser window 220-2.

In the editor window 220-1 a text stream 222-1 may be typed by a user or retrieved from a datastore. The text stream 222-1 may include one or more text enhancements. Specifically, a first text enhancement 230-1 may include a title in sans-serif font in a text size of 16 points and some text under the title in the same sans-serif font in a text size of 14 points. The first text enhancement 230-1 may be formatted with a text enhancement that makes the appearance of the text bold. The rich text may also provide a second text enhancement 232-1 of a tab spacing. The tab spacing may separate a numbered list (e.g., the numbering and the content of the numbered list). The rich text may also include a third text enhancement 234-1 of an underlined text. The first text enhancement 230-1, the second text enhancement 232-1, and the third text enhancement 234-1 may be typographical text enhancements (e.g., based on spacing and font family options). Further, there may be a fourth text enhancement 240-1 of a bulleted list. The bulleted list may include arrow glyphs. A fifth text enhancement 242-1 may be an em-dash character. A sixth text enhancement 244-1 may be a bulleted list that includes a hollow bullet character. The arrow glyphs, em-dash, and hollow bullets may be a particular type of character natively supported by the text editor 214-1.

The EATT may detect a text transfer invocation, such as a copy command of the text stream 222-1 from the text editor 214-1. Upon text transfer invocation, the text stream 222-1 may be considered a source text stream. The EATT may scan the source text stream from the text editor 214-1 that includes the text enhancements. The text enhancements may be based on a font that is used by the text editor 214-1. The text enhancement may be based on text enhancement capabilities of the text editor 214-1. The text enhancement capabilities identified may not be all of the text enhancement capabilities of the text editor 214-1. For example, the text enhancement capabilities may be a subset that are utilized by the text editor for creation of the text stream 222-1 and that are selected by the text transfer invocation.

In response to a user performing a text transfer invocation of the text stream 222-1, the EATT may intercept the text transfer invocation (e.g., a paste command). The text transfer invocation may be directed at a target processing environment. For example, the web browser 214-2, and specifically, the browser window 220-2 of the web browser. The EATT may use the target processing environment to determine the text enhancement capabilities. For example, the EATT may perform a hidden text transfer invocation of the text stream (e.g., a paste of the text hidden from the user in another instance of the web browser 214-2). The hidden text transfer invocation may be used to compare the capabilities of the source text stream (and, the text enhancement capabilities used by the source text stream) to the target processing environment. For example, the EATT may paste the text stream into a hidden web browser window of web browser 214-2 and compare the output based on image analysis to determine text enhancement capabilities that are or are not supported.

The EATT may use an image processor (not depicted) to determine that certain text enhancements are supported or not supported. The image processor may be a collection of hardware and software, such as an application specific integrated circuit. The image processor may be configured to perform various image analysis techniques. The image analysis techniques may be machine learning and/or deep learning based techniques. These techniques may include, but are not limited to, region-based convolutional neural networks (R-CNN), you only look once (YOLO), edge matching, clustering, grayscale matching, gradient matching, invariance models, geometric hashing, scale-invariant feature transform (SIFT), speeded up robust feature (SURF), histogram of oriented gradients (HOG) features, and single shot multibox detector (SSD). In some embodiments, the image processor may be configured to aid in identifying of fonts, typography, formatting and special characters (e.g., by analyzing source text from the source processing environment of the text editor 214-1 and identifying the text enhancements).

In some embodiments, objects may be identified using an object detection algorithm, such as an R-CNN, YOLO, SSD, SIFT, Hog features, or other machine learning and/or deep learning object detection algorithms. The output of the object detection algorithm may include one or more identities of one or more respective objects with corresponding match certainties. For example, a group of letters or symbols may be analyzed. Using a relevant object detection algorithm, the small caps, underlining, and letter kerning or spacing may be identified.

In some embodiments, features of the objects may be determined using a supervised machine learning model built using training data. For example, an image may be input into the supervised machine learning model and various classifications detected within the image can be output by the model. For example, characteristics such as shape, size, color, font sizing, special character usages and other characteristics may be output by the supervised machine learning model. Further, the identification of objects can be output as classifications determined by the supervised machine learning model. For example, underlined text, bold text, italic text, text size, text weight, alternative text forms, serif strokes, may be categorized as text enhancements of a font family. In another example, spacing, kerning, numbers, tabs, layout, list spacing may be categorized as text enhancements of typography support. In yet another example, en-dashes, em-dashes, bullets, arrows, circulars, marks, graves, and diacritics may be categorized as symbol support.

In some embodiments, characteristics of objects may be determined using photogrammetry techniques. For example, shapes and dimensions of objects may be approximated using photogrammetry techniques. As an example, if a user provides an image of a basket, the diameter, depth, thickness, etc. of the basket may be approximated using photogrammetry techniques. In some embodiments, characteristics of objects may be identified by referencing an ontology. For example, if an object is identified (e.g., using an R-CNN), the identity of the object may be referenced within an ontology to determine corresponding attributes of the object. The ontology may indicate attributes such as color, size, shape, use, etc. of the object.

Characteristics may include the shapes of objects, dimensions (e.g., height, length, and width) of objects, a number of objects (e.g., number of character or letter spacing to a tab whitespace character), colors of objects, and/or other attributes of objects. In some embodiments, the output may generate a list including the identity and/or characteristics of objects. In some embodiments, the output may include an indication that an identity or characteristic of an object is unknown. The indication may include a request for additional input data that can be analyzed such that the identity and/or characteristics of objects may be ascertained. In some embodiments, various objects, object attributes, and relationships between objects (e.g., hierarchical and direct relations) may be represented within a knowledge graph (KG) structure. Objects may be matched to other objects based on shared characteristics (e.g., capital and lowercase letters of a serif), relationships with other objects (e.g., character shapes and substitute or alternatives), or objects belonging to the same class (e.g., lowercase letters of similar sans serif fonts).

Based on comparing the text stream from the source processing environment (the source text) to the target processing environment, a target text stream 222-2 may be generated. The target text stream 222-2 may be generated based on supported text enhancements and determined alternative enhancements. One or more target text enhancement capabilities may be determined that are directly supported. For example, the fifth text enhancement 242-1 (e.g., the em-dash) may be directly supported by the web browser 214-2. Based on comparing the source text stream from the text editor 214-1 to the web browser 214-2 one or more target text enhancement capabilities may be determined that are not directly supported. For example, the first enhancement 230-1, the second enhancement 232-1, the third enhancement 234-1, the fourth enhancement 240-1, and the sixth enhancement 244-1 are not directly supported. The EATT may determine based on the comparison alternative enhancements. The alternative enhancements may be determined based on image processing, based on previous text transfers, or based on pre-set or pre-determined alternatives.

The generated text stream may make use of alternatives, such as the generated target text stream 222-2. For example, a first alternative enhancement 230-2 may be that all text is serif font and that bold text from the source is replaced with upper-case text. The first alternative enhancement 230-2 may be based on a default system mapping that replaces bold text with uppercase text when pasting from a text editor into a web browser. A second alternative enhancement 232-2 may be the use of two singular whitespace characters in place of a tab whitespace character. A third alternative enhancement 234-2 may be the insertion of a tag. The tag may represent that the following text is underlined or otherwise emphasized or another enhancement. The tag may be in a relevant text enhancing format (e.g., markdown, HTML, Unicode ®, etc.). The tag may be based on a mapping replacement defined by a user. A fourth alternative enhancement 240-2 may be the use of an en-dash followed by a greater-than symbol.

The fifth alternative enhancement 244-2 may be the use of an asterisk enclosed by parenthesis as a substitute for the sixth enhancement 244-1. The generated text stream may also make use of direct replacements. For example, the generated text stream may use an em-dash without an alteration or by not making an alteration to the source text stream.

After the target text stream 222-2 is generated, a second transfer invocation may be performed. At a time 250, the EATT may intercept and alter the format of text input from a user into a text processing environment. For example, time 250 may occur after the target text stream 222-2 is pasted into the browser window 220-2. The user may be inputting text into the target text stream 222-2 directly (text input), e.g., by use of a keyboard (not depicted), etc. The user may input a certain character (or series of characters) and the EATT may detect the certain character of the text input. For example, the user may input a carriage return by pressing an enter key on a keyboard attached to the computing environment 200. In response to detecting the input of the certain character, the EATT may analyze text input and intercept the text input before it is input into the target processing environment. For example, the EATT may remove a carriage return from a text-input buffer or other processing element of computing environment 200 before the text input is registered by the browser window 220-2 of the web browser 214-2. The EATT may generate an altered text input and insert the altered text input into the target processing environment. For example, based on a text input of a carriage return, the EATT may generate a carriage return of a number ‘2.’ The EATT may further generate a new line with an altered numbering scheme (e.g., by replacing “2. Screwdriver—potential issues” with “3. Screwdriver—potential issues”). The EATT may insert the altered text input into the target processing environment. By altering the input in some embodiments, the EATT may enable a user to perform text enhancements that are otherwise unsupported. For example, the web browser 214-2 may not natively support text enhancements including numbered lists. The EATT may operate outside of the web browser to manipulate and alter the text input that does not include numbers to enable native numbering of text streams before they are received by the web browser.

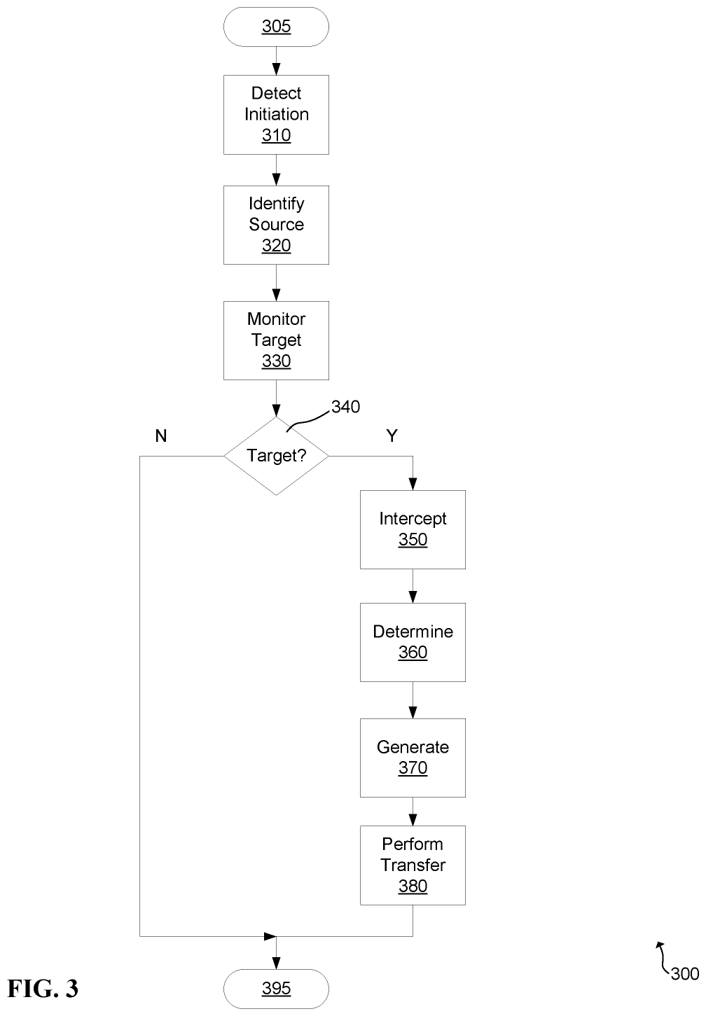

FIG. 3 depicts an example method 300 for performing EATT to manipulate text between source and target processing environments, consistent with some embodiments of the disclosure.

Method 300 begins at 305 when a text transfer initiation is detected at 310. The detection may be performed by monitoring an input queue of a computing system. The text transfer initiation may include obtaining a character, input, gesture, keystroke or other input from a user. For example, a user may press the “command” key and the “C” key in combination to indicate a text transfer and detection may be performed by monitoring for the combination. The text transfer initiation may be directed towards a source text stream. The source text stream may be located in a document that is active in a multi-application environment (e.g., a desktop computing environment on a personal computer, a smartphone computing environment on a mobile phone, etc.). The text transfer initiation may be directed towards a specific block of text and the detection may be based on the direction. For example, a computing environment may include the ability to highlight text and detection of the text transfer initiation may be based on the performance of highlighting or otherwise selecting the source text stream. In another example, a computing environment may have a text processing environment having one or more editable windows. Each of the editable windows may be capable of accepting text input from a user and creation of text streams. The detection of the text transfer initiation may include detection of a cursor located in or focus being given to one of the editable windows of the text processing environment.

At 320 a source subset of source text enhancement capabilities may be identified. The source text enhancement capabilities may be identified by analyzing the source text stream. The analysis may be image analysis, natural language processing, or another relevant technique. The analysis of the source text enhancement capabilities may include analysis of a text buffer, clipboard, or other computing construct that holds the text. For example, the text buffer may include one or more standard roman numerals or other human-facing symbols designed to convey information (e.g., plain text), and one or more other characters designed to enhance or otherwise alter the display of human-facing symbols (e.g., HTML tags, Unicode® characters, text formatting characters, etc.).

At 330 a computing environment may be monitored for a potential target of a text transfer (a potential target processing environment). Monitoring for a potential target may include monitoring selection of a potential target processing environment. For example, monitoring of input from a mouse, touchpad, touchscreen, joystick, keypad, or keyboard communicatively coupled to the computing environment. Monitoring may include scanning for a potential selection, such as clicking of a window, performing an application switch command (e.g., “alt” and “tab” on a keyboard in combination, swiping a touchpad with one or more fingers, etc.). A potential target of a text transfer may be an application or other processing environment as an active or selected program. Monitoring for a potential target processing environment may include monitoring for specific text transfer invocation. For example, a command to paste text in a potential target processing environment may include a combination of a “command” key and a “V” key on a keyboard being pressed concurrently and/or simultaneously.

If a target processing environment of a text transfer is identified, at 340:Y, the text transfer invocation and associated text stream may be intercepted at 350. Intercepting of the text transfer invocation may occur before a target processing environment performs an update to any text located within the target processing environment. For example, the text transfer invocation may be intercepted such that a word processing application does not receive, see, or otherwise access the text stream. The word processing application may be a text box or other designated area inside of or being emulated by a web browser. By intercepting, the target processing environment may not be aware of the text stream. Intercepting of the text transfer invocation may include the capturing of the text stream. For example, a source text stream may be removed from a clipboard, a memory, or other relevant computing datastore that may be the source of a text transfer invocation.

At 360 a determination may be made of potential alternative enhancements to the source subset of source text enhancements. The determination may be made by comparing the source subset of source text enhancement capabilities to one or more target text enhancement capabilities of the target processing environment. For example, by comparing the ability of typography and glyph/symbol creation of a source text processing environment that were used to create a text stream that is being copied to a list of text enhancement capabilities of a processing environment that is the target of the text transfer invocation. The determination may be based on a mapping of text enhancements and suitable alternatives. For example, a mapping for bold text may include a first entry of suitable substitution is small caps text, and a second entry of suitable substitute is uppercase text. The target processing environment may be probed to determine that a suitable alternative enhancement is supported by the target processing environment. Probing may include nearly simultaneously or concurrently with intercepting and determining alternatives, generating test text in a second instance of the target processing environment. The test text may be input into the second instance and an image processing algorithm may be run to verify that the test text corresponds to the source text stream.

At 370 a target text stream may be generated. The target text stream may be generated based on determining the one or more alternative text enhancements. For example, by replacing one or more text enhancements in the source text stream (e.g., arrow shapes, underlined text) with corresponding substitute alternative text enhancements (e.g., combinations of lesser than and dash symbols, text surrounded by a tag representative of an underlining), respectively. The alternative text enhancements may be selected from one or more target text enhancement capabilities of the target processing environment. The target text stream may also be generated based on the original text stream—for example, by generating unmodified or unaltered text and text enhancements that are supported directly by the target processing environment.

At 380 a second text transfer invocation may be performed. The second text transfer invocation may include the target text stream that was generated with the alternative text enhancements substituted for any unsupported source text enhancement capabilities. The original source text stream may be discarded, deleted, or saved in a separate application or utility for future iterations and comparison (e.g., saved outside of the target processing environment). After the second text transfer invocation was performed at 380 (or if a target processing environment was not identified at 340:N) method 300 ends at 395.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method comprising:
detecting a text transfer initiation directed towards a source text stream, the source text stream located in a source processing environment;
identifying a source subset of one or more source text enhancement capabilities of the source processing environment, the source subset applied to the source text stream;
intercepting a text transfer invocation of the source text stream, the text transfer invocation directed towards a target processing environment;
comparing the source subset to one or more target text enhancement capabilities of the target processing environment;
determining, based on the comparing, one or more alternative enhancements to the source subset;
generating, based on determining the one or more alternative enhancements, a target text stream that includes one or more alternative text enhancements, the one or more alternative text enhancements selected from the one or more target text enhancement capabilities; and
performing a second text transfer invocation directed towards the target processing environment, the second text transfer invocation including the target text stream.

2. The method of claim 1, wherein the determining is based on an application text replacement mapping, and wherein the application text replacement mapping is created based on the comparing.

3. The method of claim 1, further comprising:
detecting, after performing the second text transfer invocation, an update to the target text stream in the target processing environment;
analyzing, based on the one or more alternative enhancements, the update to the target text stream; and
updating a preference entry to an application text replacement mapping.

4. The method of claim 1, wherein the one or more source text enhancement capabilities includes a bulleted list.

5. The method of claim 1, wherein the one or more text enhancement capabilities includes typefaces.

6. The method of claim 5, wherein the one or more text enhancement capabilities includes bold text.

7. The method of claim 5, wherein the one or more text enhancement capabilities is selected from the group consisting of underlined text and italicized text.

8. The method of claim 1, wherein the source text stream is unstructured text.

9. The method of claim 1, wherein the target processing environment accepts only plain text.

10. The method of claim 1, further comprising:
detecting, after performing the second text transfer invocation, a text input in the target processing environment;
intercepting, based on detecting the text input, the text input;
generating, based on the one or more alternative enhancements, an altered text input; and
inserting the altered text input into the target processing environment.

11. A system, the system comprising:
a memory, the memory containing one or more instructions; and
a processor, the processor communicatively coupled to the memory, the processor, in response to reading the one or more instructions, configured to:
detect a text transfer initiation directed towards a source text stream, the source text stream located in a source processing environment;
identify a source subset of one or more source text enhancement capabilities of the source processing environment, the source subset applied to the source text stream;
intercept a text transfer invocation of the source text stream, the text transfer invocation directed towards a target processing environment;
compare the source subset to one or more target text enhancement capabilities of the target processing environment;
determine, based on the comparing, one or more alternative enhancements to the source subset;
generate, based on the one or more alternative enhancements, a target text stream that includes one or more alternative text enhancements, the one or more alternative text enhancements selected from the one or more target text enhancement capabilities; and
perform a second text transfer invocation directed towards the target processing environment, the second text transfer invocation including the target text stream.

12. The system of claim 11, wherein generate the target text stream is based on an application text replacement mapping, and wherein the application text replacement mapping is created based on the comparing.

13. The system of claim 11, wherein the processor is further configured to:
detect an alteration to the target text stream;
analyze, based on the one or more alternative enhancements, the alteration to the target text stream; and
update a preference entry to an application text replacement mapping.

14. The system of claim 11, wherein the one or more source text enhancement capabilities includes a bulleted list.

15. The system of claim 11, wherein the source text stream is unstructured text.

16. A computer program product, the computer program product comprising:
one or more computer readable storage media; and
program instructions collectively stored on the one or more computer readable storage media, the program instructions configured to:
detect a text transfer initiation directed towards a source text stream, the source text stream located in a source processing environment;
identify a source subset of one or more source text enhancement capabilities of the source processing environment, the source subset applied to the source text stream;
intercept a text transfer invocation of the source text stream, the text transfer invocation directed towards a target processing environment;
compare the source subset to one or more target text enhancement capabilities of the target processing environment;
determine, based on the comparing, one or more alternative enhancements to the source subset;
generate, based on the one or more alternative enhancements, a target text stream that includes one or more applied alternative text enhancements, the one or more applied alternative text enhancements selected from the one or more target text enhancement capabilities; and
perform a second text transfer invocation directed towards the target processing environment, the second text transfer invocation including the target text stream.

17. The computer program product of claim 16, wherein the one or more text enhancement capabilities includes typefaces.

18. The computer program product of claim 17, wherein the one or more text enhancement capabilities includes bold text.

19. The computer program product of claim 17, wherein the one or more text enhancement capabilities includes underlined text.

20. The computer program product of claim 16, wherein the program instructions are further configured to:
detect, after performing the second text transfer invocation, a text input in the target processing environment;
intercept, based on detecting the text input, the text input;
generate, based on the one or more alternative enhancements, an altered text input; and
insert the altered text input into the target processing environment.
